(19) United States
(12) Patent Application Publication
(10) Pub. No.: US 2015/0288595 A1
(43) Pub. Date: Oct. 8, 2015

(54) CONTROL APPARATUS, COMMUNICATION SYSTEM, CONTROL INFORMATION CREATION METHOD, AND PROGRAM

(71) Applicant: NEC CORPORATION, Minato-ku, Tokyo (JP)

(72) Inventor: Kazuya Suzuki, Tokyo (JP)

(73) Assignee: NEC CORPORATION, Minato-ku, Tokyo (JP)

(21) Appl. No.: 14/439,205

(22) PCT Filed: Nov. 14, 2013
(86) PCT No.: PCT/JP2013/080760

§ 371 Date: Apr. 28, 2015

(30) Foreign Application Priority Data
Nov. 15, 2012 (JP) 2012-250888

(51) Int. Cl. H04L 12/751; H04L 12/24

(52) U.S. Cl. CPC H04L 45/02; H04L 41/12

(57) ABSTRACT

A control apparatus includes: a route information storage unit configured to store information for obtaining a neighboring router(s) set as a next hop(s) for a destination; a path calculation unit configured to calculate a path(s) between arbitrary control target nodes on the basis of a network topology configured by a plurality of control target nodes; and control information creation units configured to create control information set in the plurality of control target nodes. Indivisual one of control information creation units, as for a destination allocated to itself among destinations obtained from the route information storage unit, creates control information for causing at least one control target node on a path(s) to forward packets to the neighboring router(s) by using a path(s) calculated by the path calculation unit.

### REFERENCE TO RELATED APPLICATION

The present invention is based upon and claims the benefit of the priority of Japanese patent application No. 2012-250888, filed on Nov. 15, 2012, the disclosure of which is incorporated herein in its entirety by reference thereto.

1. Technical Field

The present invention relates to a control apparatus, a communication system, a control information creation method, and a program. In particular, it relates to: a control apparatus that controls communication by setting control information in controlled communication nodes; a communication system; a control information creation method; and a program.

2. Background

OpenFlow has drawn attention as basic technology for realizing software-defined networks (SDNs) (see Non-Patent Literatures 1 and 2). OpenFlow recognizes communications as end-to-end flows and performs route control, failure recovery, load balancing, and optimization on a per-flow basis. Each OpenFlow switch according to Non-Patent Literature 2 has a secure channel for communication with an OpenFlow controller and operates according to a flow table suitably added or rewritten by the OpenFlow controller. In the flow table, a set of the following three is defined for each flow: match conditions (Match Fields) against which a packet header is matched; flow statistical information (Counters); and instructions that define at least one processing content (see 4.1 “Flow Table” in Non-Patent Literature 2).

For example, when an OpenFlow switch receives a packet, the OpenFlow switch searches the flow table for an entry having a match condition that matches header information of the received packet (see 4.3 “Match Fields” in Non-Patent Literature 2). If, as a result of the search, the OpenFlow switch finds an entry that matches the received packet, the OpenFlow switch updates the flow statistical information (Counters) and processes the received packet on the basis of a processing content(s) (packet transmission from a specified port, flooding, dropping, etc.) written in the Instructions field of the entry. If, as a result of the search, the OpenFlow switch does not find an entry that matches the received packet, the OpenFlow switch transmits an entry setting request to the OpenFlow controller via the secure channel. Namely, the OpenFlow switch requests the OpenFlow controller to transmit control information for processing the received packet (Packet-In message). The OpenFlow switch receives a flow entry that defines a processing content(s) and updates the flow table. In this way, by using an entry stored in the flow table as control information, the OpenFlow switch performs packet forwarding.

### CITATION LIST

### Non-Patent Literature

Non-Patent Literature 1:

Nick McKeown, and seven others, “OpenFlow: Enabling Innovation in Campus Networks,” [online], [searched on Oct. 24, 2012], Internet

<URL:http://www.openflow.org/documents/openflow-wp-latest.pdf>

Non-Patent Literature 2:

“OpenFlow Switch Specification” Version 1.1.0 Implemented (Wire Protocol 0x02), [online], [searched on Oct. 24, 2012], Internet <URL:http://www.openflow.org/documents/openflow-spec-v1.1.0.pdf>

### SUMMARY

### Technical Problem

The following analysis has been given by the present inventor. If a centralized-control-type network using OpenFlow in the above Non-Patent Literatures 1 and 2 is connected to an Internet-Protocol-(IP-)based network, a user packet received by a switch controlled in the OpenFlow network needs to be forwarded to an appropriate neighboring router. However, to appropriately forward the packet, a control apparatus (for example, an OpenFlow controller) needs to acquire route information from a neighboring router(s) or the like, calculate a path(s) on the basis of the content of the path information, and set control information for instructing packet(s) forwarding in relevant communication nodes controlled in the OpenFlow network.

If a centralized-control-type network is connected to many external networks as described above, the number of destinations that need to be reflected on flow entries is increased. Thus, there is a problem that the load on the control apparatus is increased.

It is an object of the present invention to provide a control apparatus, a communication system, a control information creation method, and a program that contribute to reducing the load for creating control information and improving the ability of creating the control information in a case where a centralized-control-type network as typified by an OpenFlow network in Non-Patent Literatures 1 and 2 is connected to an existing network.

### Solution to Problem

According to a first aspect, there is provided a control apparatus, including: a route information storage unit configured to store information for obtaining a neighboring router(s) set as a next hop(s) for a destination; a path calculation unit configured to calculate a path(s) between arbitrary control target nodes on the basis of a network topology configured by a plurality of control target nodes; and a plurality of control information creation units configured to create control information set in the plurality of control target nodes; wherein, indivisual one of control information creation units, as for a destination allocated to itself among destinations obtained from the route information storage unit, creates control information for causing at least one control target node on a path(s) to forward packets to the neighboring router(s) by using a path(s) calculated by the path calculation unit.

According to a second aspect, there is provided a communication system including a plurality of control target nodes and the above control apparatus.

According to a third aspect, there is provided a control information creation method, including steps of: causing a control apparatus, which comprises: a route information storage unit configured to store information for obtaining a neighboring router(s) set as a next hop(s) for a destination; a path calculation unit configured to calculate a path(s) between arbitrary control target nodes on the basis of a network topology configured by a plurality of control target nodes; and a plurality of control information creation units configured to create control information set in the plurality of control target nodes, to determine whether or not a destination obtained from the route information storage unit is a destination allocated to itself, by indivisual one of the control information creation units; and causing the control apparatus, to create control information for causing at least one control target node on a path(s) to forward packets to a neighboring router(s) determined as allocated to itself by using a paths(s) calculated by the path calculation unit.

This method is associated with a certain machine, namely, with a control apparatus that creates control information set in a plurality of control target nodes.

According to a fourth aspect, there is provided a program, causing a computer, which constitutes a control apparatus comprising: a route information storage unit configured to store information for obtaining a neighboring router(s) set as a next hop(s) toward a destination; a path calculation unit configured to calculate a path(s) between arbitrary control target nodes on the basis of a network topology configured by a plurality of control target nodes; and a plurality of control information creation units configured to create control information set in the plurality of control target nodes, to perform processing for: determine whether or not a destination obtained from the route information storage unit is a destination allocated to itself, by indivisual one of the control information creation units; and creating control information, as to a destination determined as allocated to itself, for causing at least one of the control target nodes on a path(s) to forward packets to the neighboring router(s) by using a path(s) calculated by the path calculation unit.

### Advantageous Effects of Invention

The present invention can contribute to reducing the load for creating control information and improving the ability of creating the control information in a case where a centralized-control-type network is connected to an existing network.

### BRIEF DESCRIPTION OF THE DRAWINGS

FIG. 1 illustrates a configuration according to an exemplary embodiment of the present invention.

FIG. 2 illustrates a configuration of a control apparatus according to a first exemplary embodiment of the present invention.

FIG. 3 illustrates exemplary route information stored in the control apparatus according to the first exemplary embodiment of the present invention.

FIG. 4 illustrates an operation of the control apparatus according to the first exemplary embodiment of the present invention.

FIG. 5 illustrates an exemplary address resolution table stored in the control apparatus according to the first exemplary embodiment of the present invention.

FIG. 6 illustrates a shortest path tree used in the first exemplary embodiment of the present invention.

FIG. 7 illustrates an exemplary interface table stored in the control apparatus according to the first exemplary embodiment of the present invention.

FIG. 8 is a flowchart illustrating an operation of the control apparatus according to the first exemplary embodiment of the present invention.

FIG. 9 illustrates an operation of the control apparatus according to the first exemplary embodiment of the present invention.

FIG. 10 illustrates an operation of the control apparatus according to the first exemplary embodiment of the present invention.

FIG. 11 illustrates a configuration of a control apparatus according to a second exemplary embodiment of the present invention.

FIG. 12 is a diagram illustrating allocation of path calculation units and a shortest path tree according to the second exemplary embodiment of the present invention.

FIG. 13 is another diagram illustrating allocation of path calculation units and a shortest path tree according to the second exemplary embodiment of the present invention.

FIG. 14 is a flowchart illustrating an operation of the control apparatus according to the second exemplary embodiment of the present invention.

FIG. 15 illustrates exemplary route information stored in a control apparatus according to a third exemplary embodiment of the present invention.

FIG. 16 is a flowchart illustrating an operation of the control apparatus according to the third exemplary embodiment of the present invention.

### MODES FOR CARRYING OUT THE INVENTION

First, an outline of an exemplary embodiment of the present invention will be described with reference to the drawings. In the following outline, various components are denoted by reference characters for the sake of convenience. Namely, the following reference characters are merely used as examples to facilitate understanding of the present invention, not to limit the present invention to the illustrated modes.

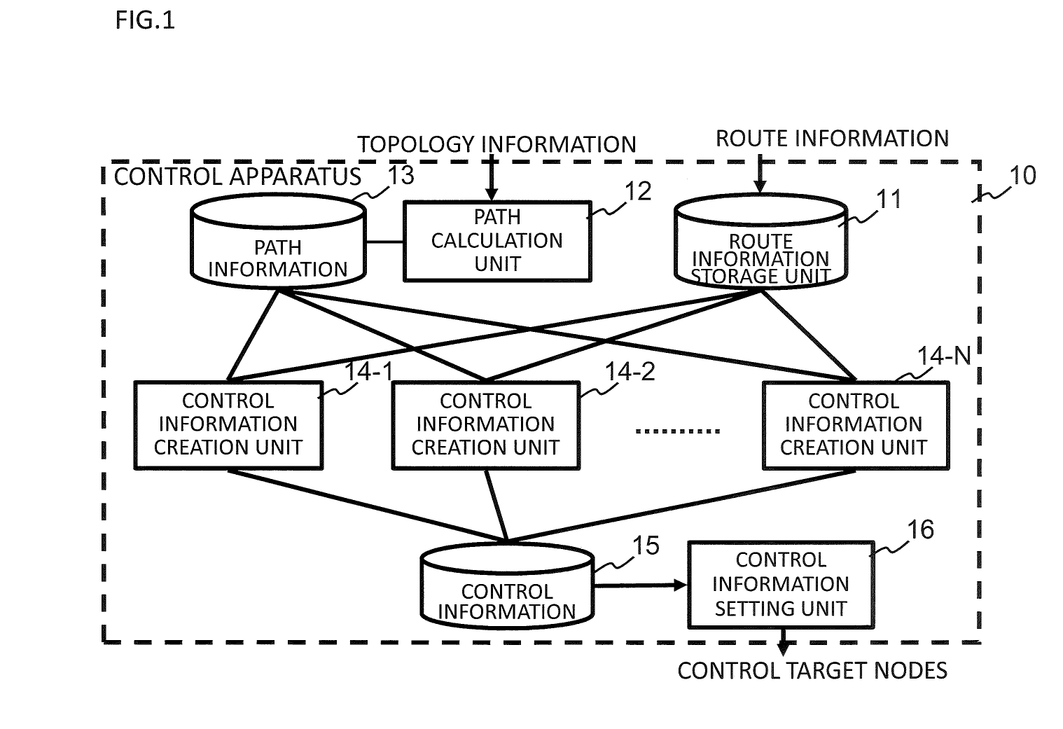

As illustrated in FIG. 1, an exemplary embodiment of the present invention can be realized by a configuration including: a route information storage unit 11 configured to store information for obtaining a neighboring router(s) set as a next hop(s) for a destination; a path calculation unit 12 configured to calculate a path(s) between arbitrary control target nodes on the basis of a network topology (topology information) configured by a plurality of control target nodes; and control information creation units 14-1 to 14-N configured to create control information set in the plurality of control target nodes.

More specifically, indivisual one of the N control information creation units 14-1 to 14-N obtains a destination from the route information storage unit 11 and determines that the destination is allocated to itself and creates control information for causing at least one control target node on a path(s) to forward packets the neighboring router(s) by using a path(s) calculated by the path calculation unit 12. While, in the example in FIG. 1, a control information setting unit 16 sets the control information created by the control information creation units 14-1 to 14-N in relevant control target nodes, another apparatus other than the control apparatus 10 may be allowed to perform control information setting processing.

In accordance with the above configuration, load balancing for creating control information can be achieved by the N control information creation units. In this way, it is possible to reduce the load required for creating control information in a case where a centralized-control-type network and an existing network are connected to each other. Namely, it is possible to improve the ability of creating the control information.

### First Exemplary Embodiment

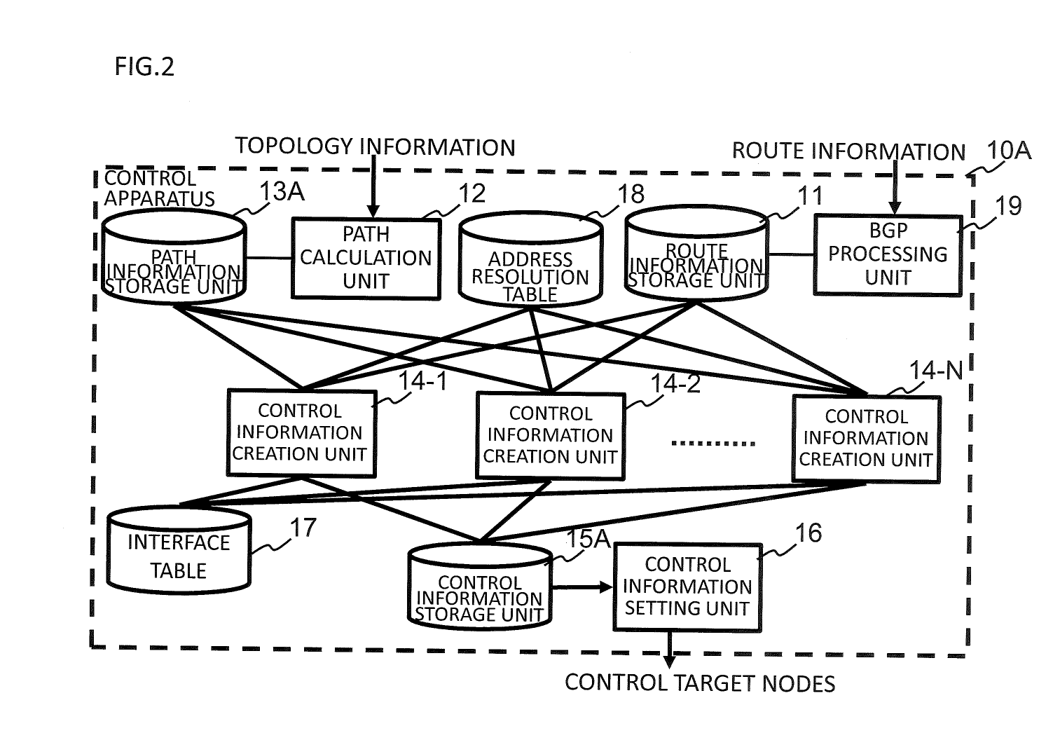

Next, a first exemplary embodiment of the present invention will be described in detail with reference to the drawings. FIG. 2 illustrates a configuration of a control apparatus according to the first exemplary embodiment of the present invention. As illustrated in FIG. 2, the configuration includes: a route information storage unit 11, a path calculation unit 12, a path information storage unit 13A, N control information creation units 14-1 to 14-N, a control information storage unit 15A, a control information setting unit 16, an interface table 17, an address resolution table 18, and a BGP processing unit 19.

By using the border gateway protocol (BGP), the BGP processing unit 19 acquires route information from other neighboring routers and stores the acquired route information in the route information storage unit 11.

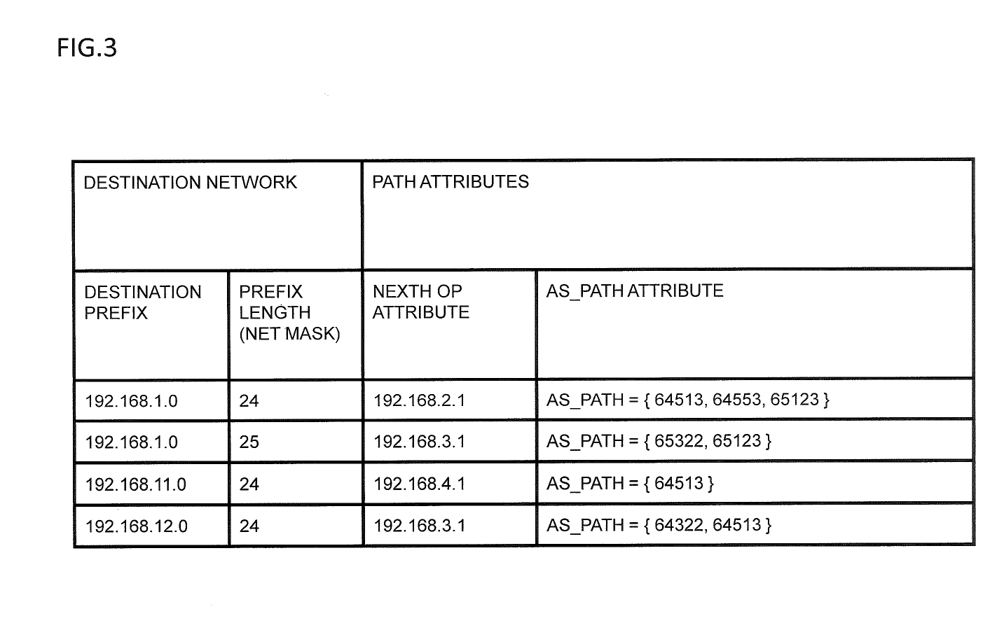

FIG. 3 illustrates exemplary route information stored in the route information storage unit 11. FIG. 3 illustrates route information entries, in each of which destination network information including a destination prefix (address prefix) and a prefix length and path attributes are associated with each other. In FIG. 3, a nexthop attribute indicates an IP address of a neighboring router that is set as a next hop toward a destination address. In addition, an AS_PATH attribute indicates at least one autonomous system (AS) used from an autonomous system (AS) as a source of route information to a neighboring router that has transmitted the route information. While a nexthop attribute and an AS_PATH attribute are stored as the path attributes in the example in FIG. 3, other path attributes defined in RFC1771, RFC1997, RFC2796, etc. or vendor-defined path attributes (for example, “Weight” of Cisco Systems, Inc.) may be included.

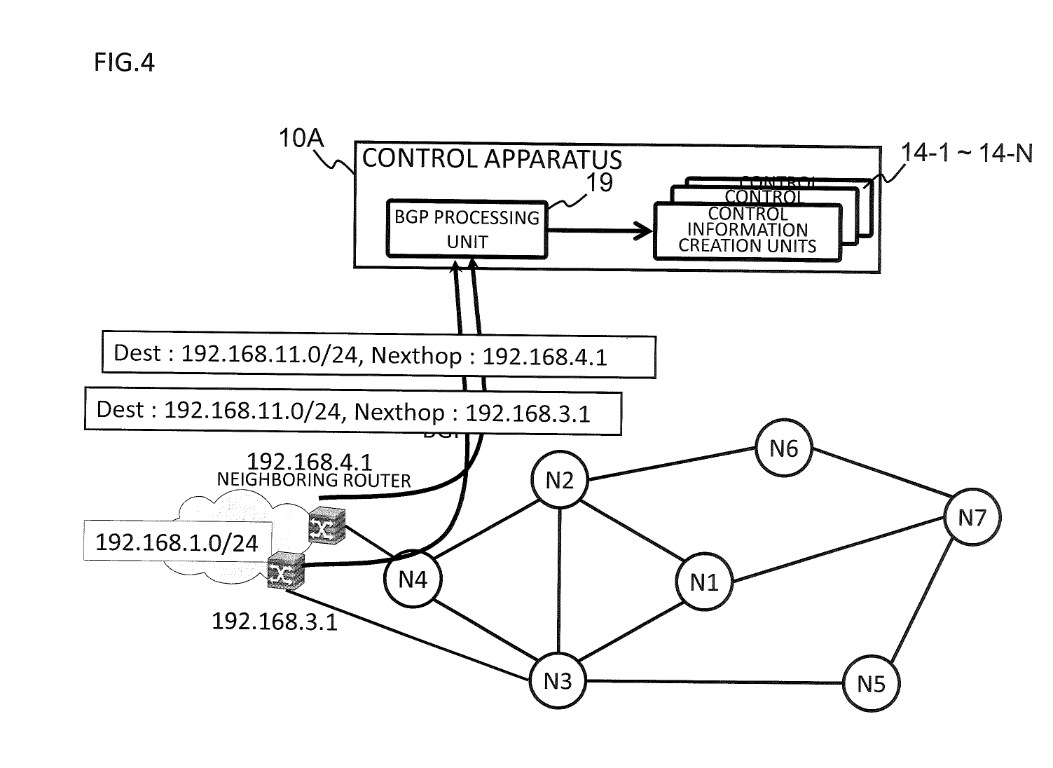

For example, as illustrated in FIG. 4, when receiving route information indicating the same destination from a plurality of neighboring routers, the control apparatus refers to the path attributes including the AS_PATH attribute to select a route (next hop) to be used. In the example in FIG. 4, the control apparatus has received two items of path information: one indicating 192.168.11.0/24 as the destination network information and 192.168.4.1 as the next hop and the other indicating 192.168.11.0/24 as the destination network information and 192.168.3.1 as the next hop. In such case, by using a predetermined best path selection algorithm, on the basis of “Weight,” the number of ASs used, or the like, a route stored in the route information storage unit 11 is selected. In the present exemplary embodiment, the control apparatus 10A includes the BGP processing unit 19 for autonomously collecting route information from neighboring router(s). However, alternatively, a network administrator may set route information illustrated as an example in FIG. 3.

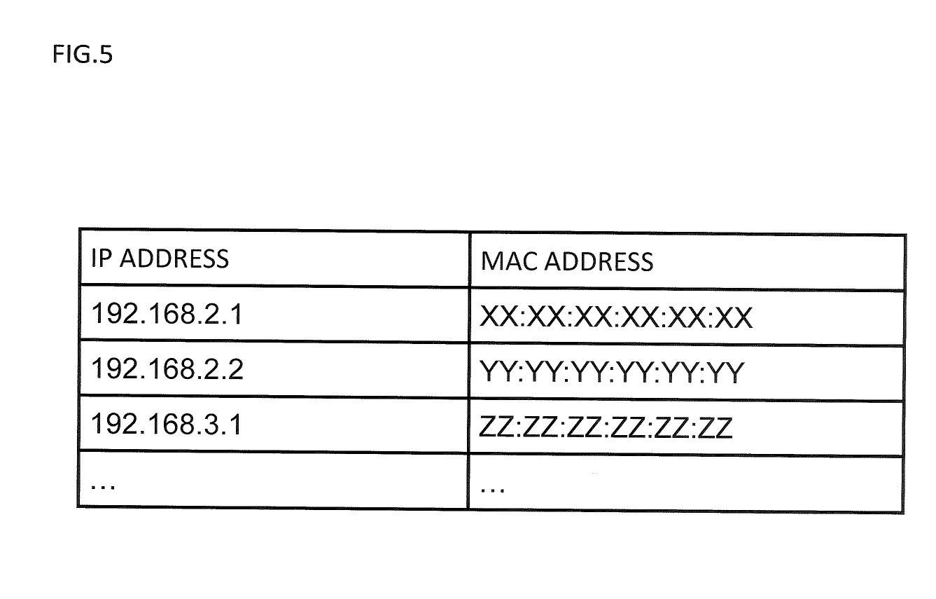

FIG. 5 illustrates entries stored in the address resolution table 18. The address resolution table 18 is configured in the same way as a so-called address resolution protocol (ARP) table including at least one entry in which an IP address and a MAC address are associated with each other. The control information creation units 14-1 to 14-N refer to the address resolution table 18 when resolving a MAC address associated with an IP address specified as a destination. The control apparatus 10A may collect these entries stored in the address resolution table 18 by using ARP or a network administrator may manually set these entries.

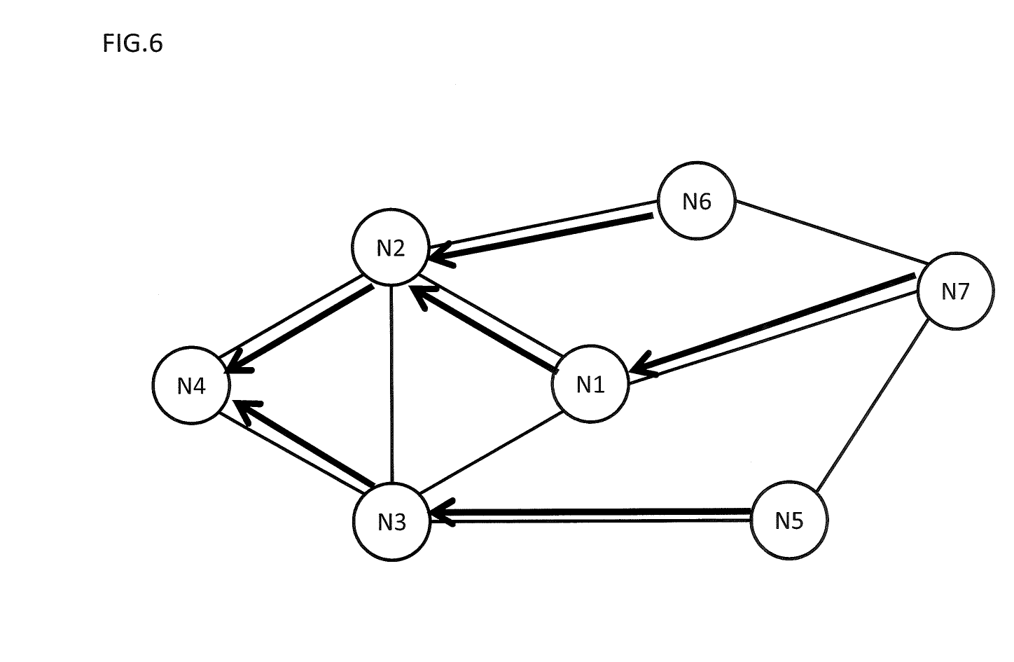

The path calculation unit 12 refers to a network topology configured by communication nodes as control targets (control target nodes) and calculates shortest path(s) between control target nodes to which neighboring routers, terminals, etc. could be connected. FIG. 6 illustrates a shortest path tree calculated by the path calculation unit 12 in which a control target node N4 is set as a sink (end point).

Each shortest path in the shortest path tree calculated by the path calculation unit 12 is stored in the path information storage unit 13A. For example, in the case of FIG. 6, a control target node N1 alone is a core node that is not connected to any neighboring routers, terminals, etc. Thus, the path calculation unit 12 calculates a shortest path tree(s) in which the control target nodes N2 to N7 are set as sinks, respectively. Of course, if there is a combination(s) of control target nodes or a path(s) on which relevant communication cannot be performed, path calculation may be omitted for such portion(s).

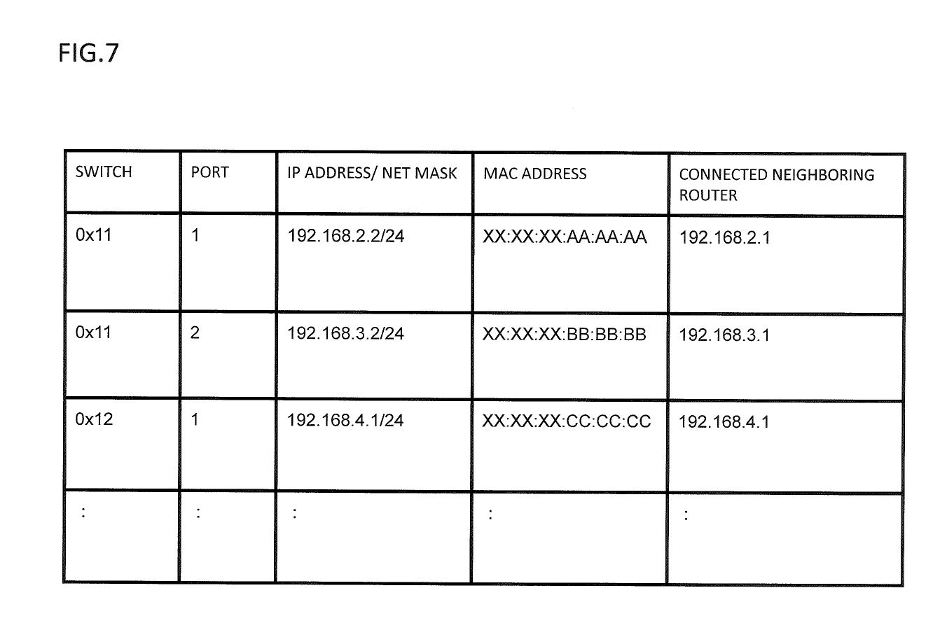

FIG. 7 illustrates entries stored in the interface table 17. The interface table 17 is a table for storing at least one entry in which an IP address and a MAC address are allocated to a port of a control target node (switch), the port being connected to a neighboring router. Each of the control information creation units 14-1 to 14-N refers to the IP and MAC addresses stored in the interface table 17 when generating control information for causing a control target node connected to a neighboring router to rewrite the header of a packet that is transmitted to the neighboring router. The control apparatus 10A may set these entries stored in the interface table 17 on the basis of a predetermined allocation rule or a network administrator may manually set these entries.

A neighboring router(s) is allocated to each of the control information creation units 14-1 to 14-N by using the IP address(es) of the neighboring router(s). When one of the control information creation units 14-1 to 14-N refers to the route information stored in the route information storage unit 11 and determines that the neighboring router associated with the target destination is a neighboring router allocated to itself, this control information creation unit acquires a shortest path tree, in which a control target node connected to this neighboring router is set as a sink, from the path information storage unit 13A. Next, the control information creation unit creates items of control information for causing relevant control target nodes to forward relevant packets in accordance with each shortest path in the shortest path tree and stores the created control information in the control information storage unit 15A. Information about the destination in the route information and other information for identifying a corresponding neighboring router are set as match conditions in each of these items of control information. In this way, each control target node on a shortest path can identify packets to be transmitted to a corresponding neighboring router.

Each unit (processing means) of the control apparatus 10A illustrated in FIG. 2 can be realized by a computer program which causes a computer that constitutes the control apparatus 10A to use its hardware and execute the above processing.

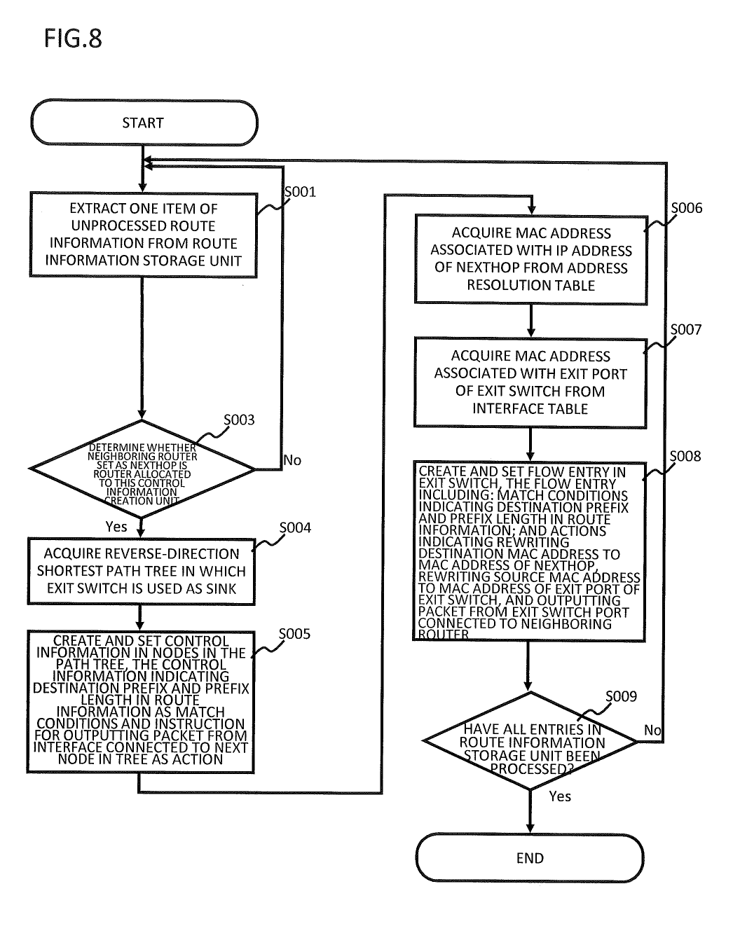

Next, an operation according to the first exemplary embodiment of the present invention will be described in detail with reference to the drawings. FIG. 8 is a flowchart illustrating an operation of the control apparatus according to the first exemplary embodiment of the present invention. As illustrated in FIG. 8, first, one (herein, the control information creation unit 14-1) of the control information creation units 14-1 to 14-N extracts one item of route information from the route information storage unit 11 (step S001).

Next, the control information creation unit 14-1 determines whether the neighboring router set in the path attribute (NEXTHOP attribute) in the extracted route information is a neighboring router that is allocated to this control information creation unit 14-1 (step S003). If the route information extracted in step S001 indicates a router that is not allocated to the control information creation unit 14-1, the processing returns to step S001 and the control information creation unit 14-1 reads the next item of route information (No in step S003).

If the neighboring router set in the path attribute (NEXTHOP attribute) in the extracted route information is a neighboring router that is allocated to the control information creation unit 14-1 (Yes in step S003), the control information creation unit 14-1 acquires a reverse-direction shortest path tree, in which the control target node (exit switch) connected to the neighboring router specified in the route information is set as a sink, from the path information storage unit 13A (step S004).

Next, the control information creation unit 14-1 creates control information for causing the control target nodes on the paths in the acquired shortest path tree to forward packets addressed to the destination specified in the route information in accordance with the respective paths (step S005). More specifically, the control information creation unit 14-1 creates control information in which the destination prefix and the prefix length in the route information are set as match conditions and an instruction for outputting packets from an interface connected to the next control target node on the corresponding path is set as an action. The control information setting unit 16 sets the created control information in the relevant control target nodes.

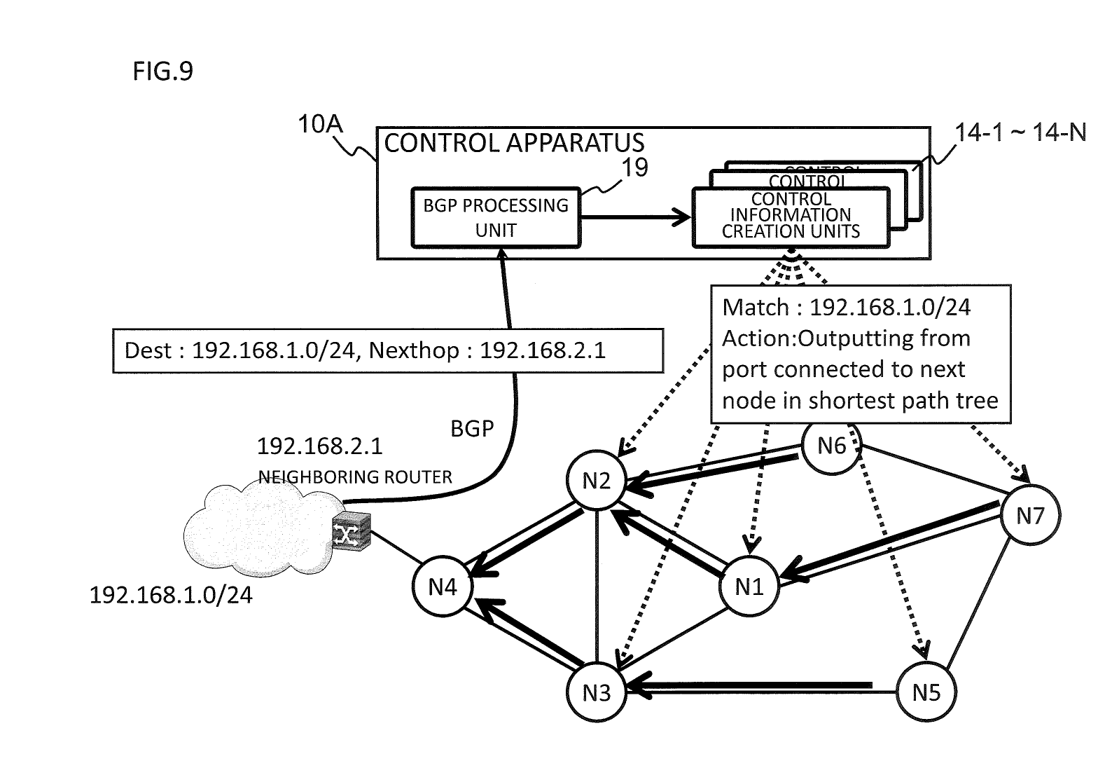

FIG. 9 illustrates the operation of the control information creation unit in step S005. The following description will be made, assuming that the BGP processing unit 19 has received route information indicating that the destination is 192.168.1.0/24 and the IP address of the neighboring router set as the next hop is 192.168.2.1 and that the control information creation unit 14-1 has determined that the neighboring router is a neighboring router allocated to itself. In this example, the control information creation unit 14-1 acquires a shortest path tree in which the control target node N4 connected to the neighboring router 192.168.2.1 is set as the sink (see arrows in FIG. 9). Next, the control information creation unit 14-1 sets control information in each of the control target nodes on the arrows in FIG. 9. In each item of control information, the destination “192.168.1.0/24” is set as a match condition and an instruction for performing packet forwarding as illustrated in a corresponding one of the arrows is set as an action. In this way, when any one of the control target nodes N1 to N7 other than the control target node N4 receives a packet addressed to the destination “192.168.1.0/24,” this control target node forwards the packet toward the control target node N4.

In addition, the control information creation unit 14-1 refers to the address resolution table 18 to acquire a MAC address associated with the IP address of the neighboring router set as the next hop in the route information (step S006).

The control information creation unit 14-1 refers to the interface table 17 to acquire a MAC address of the corresponding exit port of the control target node (exit switch) serving as the sink in the shortest path tree (step S007).

Next, the control information creation unit 14-1 creates control information for causing the control target node (exit switch) serving as the sink in the acquired shortest path tree to rewrite the MAC address, regarding packets addressed to the destination specified in the route information (step S008). More specifically, the control information creation unit 14-1 creates control information including: match conditions indicating the destination prefix and the prefix length in the route information; and actions indicating rewriting the destination MAC address to the MAC address of the neighboring router acquired in step S006, rewriting the source MAC address to the MAC address of the exit port of the exit switch acquired in step S007, and outputting packets from the exit switch port. The control information setting unit 16 sets the created control information in the control target node (exit switch) serving as the sink in the acquired shortest path tree.

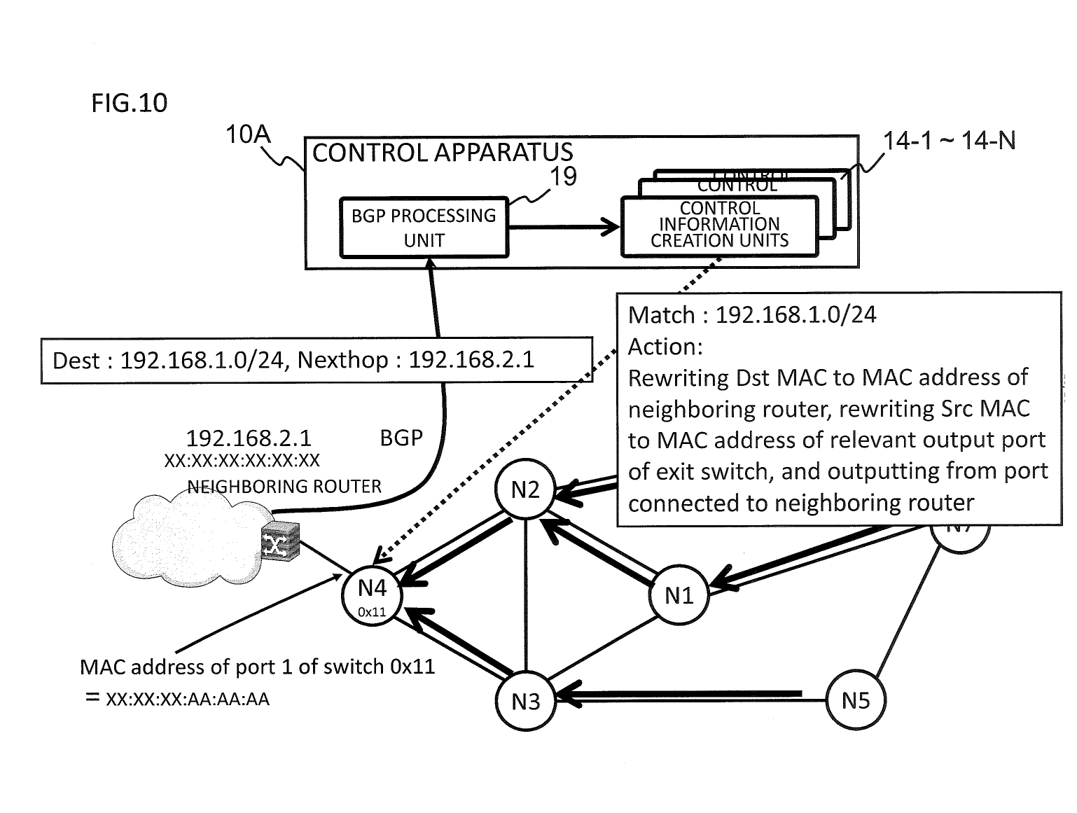

FIG. 10 illustrates an operation of the control information creation unit in the above step S008. For example, assuming that the control apparatus 10A has acquired XX:XX:XX:AA:AA:AA as the MAC address of the neighboring router in step S006 and XX:XX:XX:XX:XX:XX as the MAC address of the port of the control target node (exit switch) serving as the sink in the shortest path tree in step S007, the port being connected to the neighboring router, the control information creation unit 14-1 sets control information for rewriting the destination MAC address in the header of a packet indicating 192.168.1.0/24 as the destination to XX:XX:XX:AA:AA:AA and rewriting the source MAC address to XX:XX:XX:XX:XX:XX. In this way, when receiving this packet, the destination can appropriately specify the destination of a response packet.

Next, the control information creation unit 14-1 determines whether the setting of control information has been completed for all the necessary entries stored in the route information storage unit 11 (step S009). If, as a result of the determination, all the entries have not been processed (No in step S009), the processing returns to step S001 and the control information creation unit 14-1 extracts one item of unprocessed route information.

In contrast, if all the entries have been processed (Yes in step S009), the control information creation unit 14-1 ends the processing. While the operation of only the control information creation unit 14-1 is described in the above example, other control information creation units 14-2 to 14-N operate in the same way.

In this way, by causing each of the control information creation units 14-1 to 14-N to set control information regarding a neighboring router(s) allocated to itself, the setting for forwarding packets to a neighboring router(s) connected to the network configured by the control target nodes N1 to N7 is completed.

As is clear from the above description, according to the present exemplary embodiment, load balancing for generating control information can be achieved by the plurality of control information creation units 14-1 to 14-N.

### Second Exemplary Embodiment

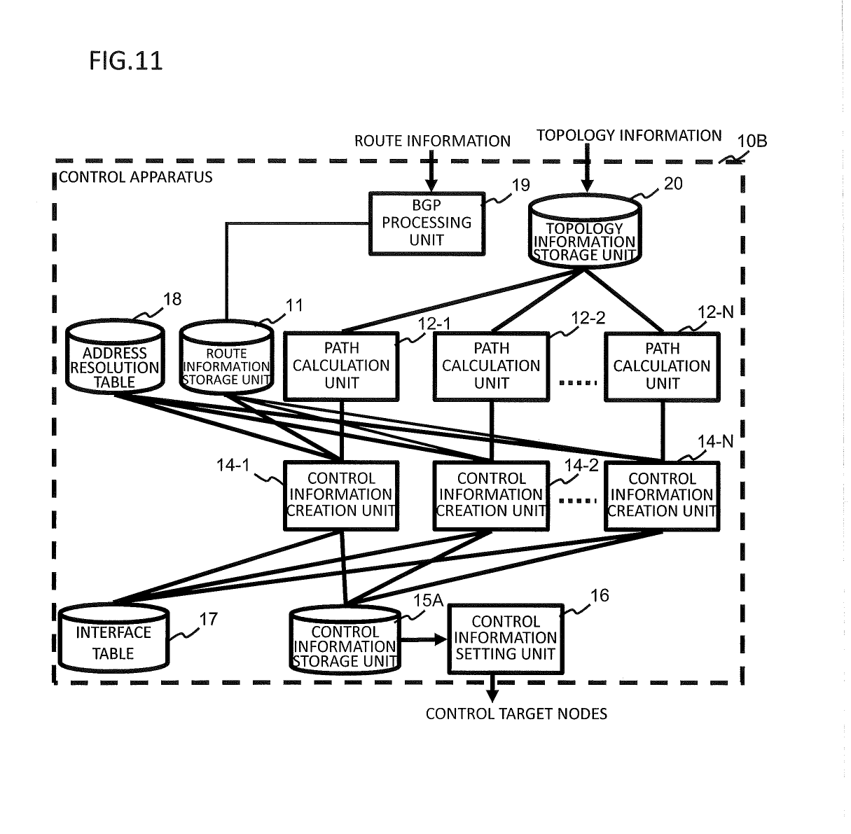

Next, a second exemplary embodiment of the present invention will be described in detail with reference to the drawings. In the second exemplary embodiment, load balancing can also be achieved by a plurality of path calculation units 12. FIG. 11 illustrates a configuration of a control apparatus 10B according to the second exemplary embodiment of the present invention. The second exemplary embodiment differs from the first exemplary embodiment illustrated in FIG. 2 in that a plurality of path calculation units are arranged for the control information creation units, respectively, and that a topology information storage unit 20 for storing topology information is added. Since other components are the same as those according to the first exemplary embodiment, the following description will be made with a focus on the differences from the first exemplary embodiment.

The topology information storage unit 20 stores a network topology configured by controlled communication nodes (control target nodes).

N path calculation units (12-1 to 12-N) according to the present exemplary embodiment are arranged for the control information creation units (14-1 to 14-N), respectively.

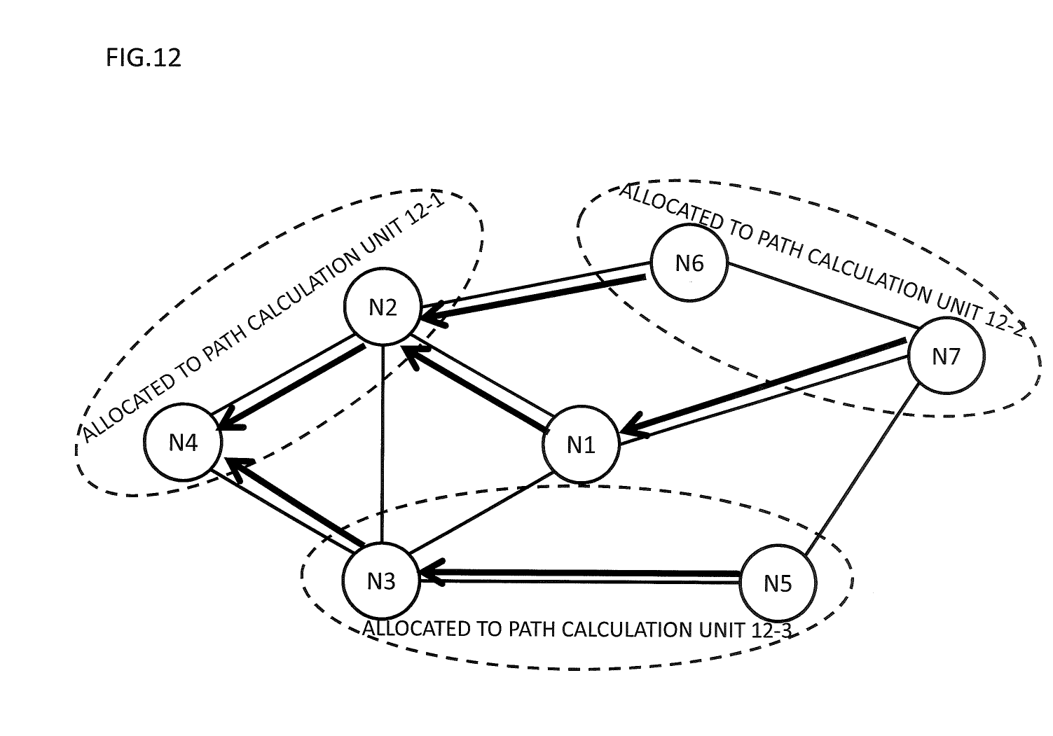

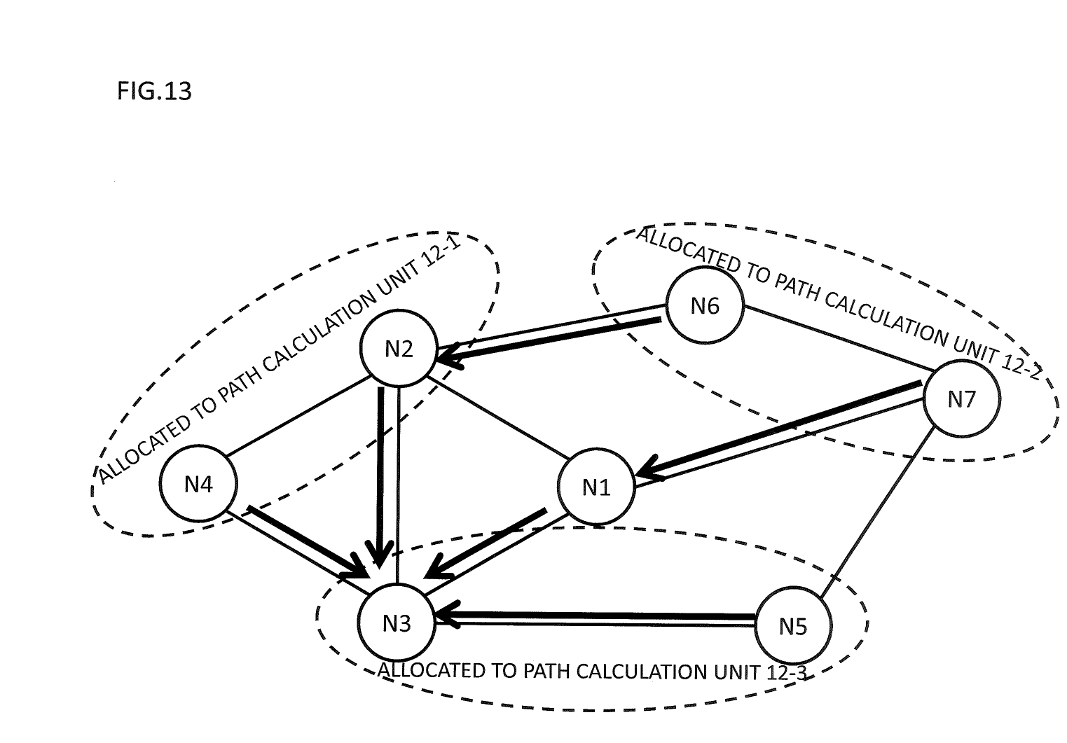

FIGS. 12 and 13 illustrate exemplary allocation of the control target nodes N2 to N7 to the path calculation units 12-1 to 12-N and shortest path trees created by each of the path calculation units 12-1 to 12-N. In the example in FIG. 12, the control target nodes N2 and N4 are allocated to the path calculation unit 12-1. In this case, the path calculation unit 12-1 calculates a shortest path tree in which the control target node N4 illustrated in FIG. 12 is set as the sink. The path calculation unit 12-1 also calculates a shortest path tree(s) in which the control target node N2 is set as the sink (not illustrated).

In the example in FIG. 13, the control target nodes N3 and N5 are allocated to the path calculation unit 12-2. In this case, the path calculation unit 12-2 calculates a shortest path tree in which the control target node N3 illustrated in FIG. 13 is set as the sink. The path calculation unit 12-1 also calculates a shortest path tree in which the control target node N5 is set as the sink (not illustrated). Likewise, the control target nodes N6 and N7 are allocated to the path calculation unit 12-3. The path calculation unit 12-3 calculates shortest path trees in which the control target nodes N6 and N7 are set as the sinks, respectively.

When any one of the control information creation units 14-1 to 14-N according to the present exemplary embodiment refers to the route information stored in the route information storage unit and determines that the control target node (exit switch) connected to the neighboring router associated to the destination is a control target node allocated to this control information creation unit, the control information creation unit acquires a shortest path tree in which the control target node connected to the neighboring router is set as the sink from an associated one of the path information calculation units 12-1 to 12N. Next, the control information creation unit creates control information for causing relevant control target nodes to forward relevant packets in accordance with each shortest path in the shortest path tree and stores the created control information in the control information storage unit 15A.

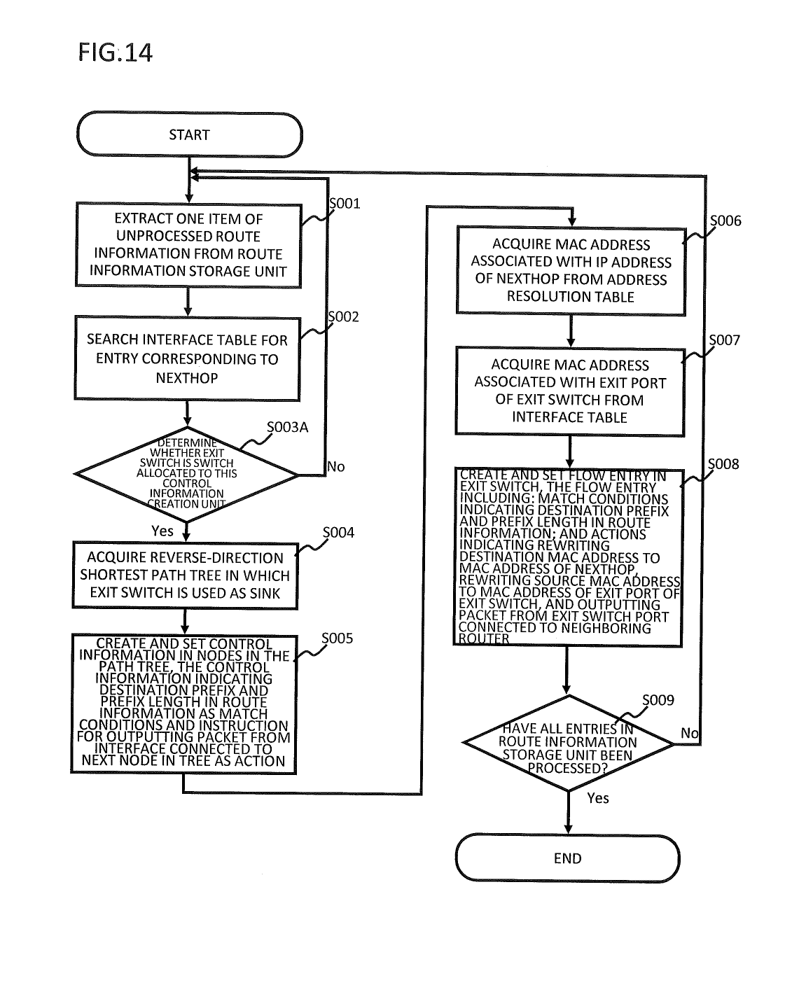

Next, an operation according to the second exemplary embodiment of the present invention will be described in detail with reference to the drawings. FIG. 14 is a flowchart illustrating an operation of the control apparatus according to the second exemplary embodiment of the present invention. This operation differs from the operation according to the first exemplary embodiment illustrated in FIG. 8 in that any one of the control information creation units 14-1 to 14-N reads information about the control target node (exit switch) connected to the neighboring router from an entry corresponding to the next hop in the interface table 17 in step S002 and determines whether the control target node is allocated to this control information creation unit (step S003A). Since other steps are the same as those according to the first exemplary embodiment, description thereof will be omitted.

Thus, according to the present exemplary embodiment, load balancing for path calculation can be achieved.

### Third Exemplary Embodiment

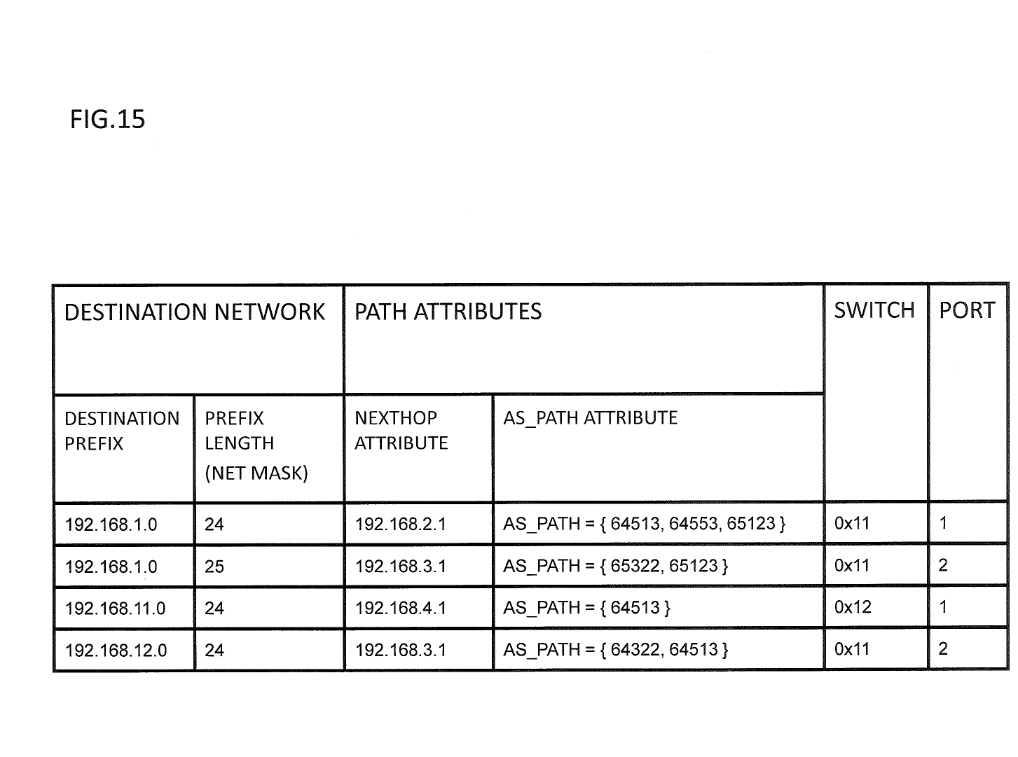

Next, a third exemplary embodiment of the present invention will be described in detail with reference to the drawings. In the third exemplary embodiment, the route information in the control apparatus according to the second exemplary embodiment is modified. FIG. 15 illustrates exemplary route information stored in a control apparatus according to the third exemplary embodiment of the present invention. The route information differs from that according to the first exemplary embodiment illustrated in FIG. 3 in that a control target node (exit switch) connected to a neighboring router set as a next hop and corresponding port information are previously stored in each entry. Since other components are the same as those according to the second exemplary embodiment, description thereof will be omitted.

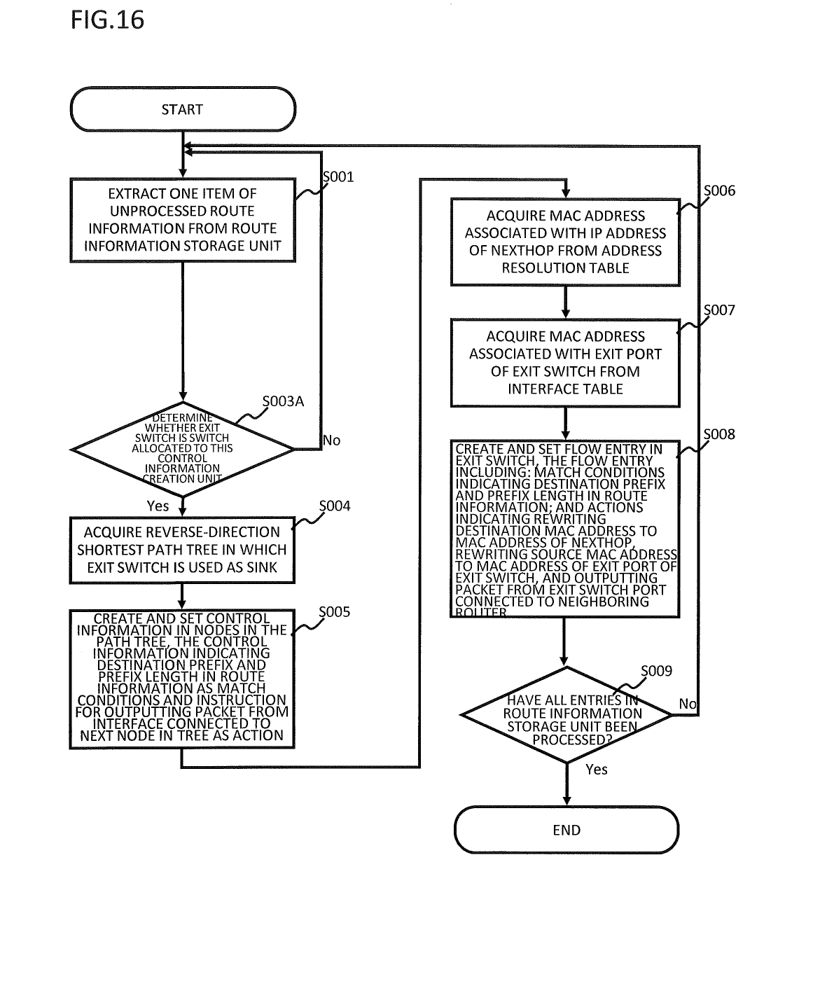

Next, an operation according to the present exemplary embodiment will be described in detail with reference to the drawings. FIG. 16 is a flowchart illustrating an operation of the control apparatus according to the third exemplary embodiment of the present invention. This operation differs from that according to the first exemplary embodiment illustrated in FIG. 8 in that the entry search processing by the interface table 17 in step S002 is omitted. This is because, as described above, a control target node (exit switch) connected to a neighboring router set as a next hop and corresponding port information are previously stored in each entry in the route information. Since other steps are the same as those according to the second exemplary embodiment, description thereof will be omitted.

As described above, the present invention can also be realized by a mode in which a control target node (exit switch) connected to a neighboring router set as a next hop and corresponding port information are previously stored in each entry in the route information. Of course, instead of such control target node (exit switch) and corresponding port information, an identifier of a corresponding route information creation unit may previously be stored, for example. In this way, each route information creation unit determines whether route information is directed thereto.

While exemplary embodiments of the present invention have thus been described, the present invention is not limited thereto. Further variations, substitutions, or adjustments can be made without departing from the basic technical concept of the present invention. For example, the configurations of the networks and elements illustrated in the drawings are used only as examples to facilitate understanding of the present invention. Namely, the present invention is not limited to the configurations illustrated in the drawings.

In addition, for example, in the above second and third exemplary embodiments, the path calculation units 12-1 to 12-N are associated with the control information creation units 14-1 to 14-N, respectively. Alternatively, one of the path calculation units 12-1 to 12-N may be associated with a plurality of control information creation units. Still alternatively, a plurality of path calculation units 12-1 to 12-N may be associated with a single control information creation unit.

In addition, in the above exemplary embodiments, the control apparatus includes the BGP processing unit 19 to acquire route information from neighboring routers. However, the route information may be acquired by using other routing protocols.

Finally, suitable modes of the present invention will be summarized.

### [Mode 1]

(See the control apparatus according to the above first aspect)

### [Mode 2]

The control apparatus according to mode 1,
wherein at least one neighboring router is allocated to each of the control information creation units; and
wherein, said each of control information creation units obtains a destination from the route information storage unit and determines that the destination is a destination allocated to itself depending on or not the obtained destination corresponds to a neighboring router allocated to the control information creation unit.

### [Mode 3]

The control apparatus according to mode 1, comprising:

an interface information storage unit in which information about the neighboring router(s) stored in the route information storage unit and information about the control target nodes connected to a neighboring router(s) are associated with each other;

wherein at least one control target node is allocated to each of the control information creation units; and

wherein, when said each of control information creation units obtains a destination from the route information storage unit and determines that the destination is a destination allocated to itself depending on or not that the obtained destination corresponds to a neighboring router connected to a control target node allocated to the control information creation unit itself.

### [Mode 4]

The control apparatus according to mode 3;

wherein the path calculation unit is provided in plurality; and

wherein each of the path calculation units calculates at least one path in which a control target node allocated to itself is set as a sink and provides a control information creation unit to which the control target node is allocated with the path.

### [Mode 5]

The control apparatus according to any one of modes 1 to 4;

wherein the path calculation unit selects one of the plurality of control target nodes and calculates a shortest path tree in which the control target node is set as a sink.

### [Mode 6]

The control apparatus according to any one of modes 1 to 5;

wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

### [Mode 7]

The control apparatus according to any one of modes 1 to 6, further comprising a border gateway protocol processing unit configured to acquire path information from a router in a neighboring autonomous system and store the path information in the route information storage unit.

### [Mode 8]

(See the communication system according to the above second aspect)

### [Mode 9]

(See the control information creation method according to the above third aspect)

### [Mode 10]

(See the program according to the above fourth aspect)

The above modes 8 to 10 can be expanded in the same way as mode 1 is expanded to modes 2 to 7.

The disclosure of each of the above Non-Patent Literatures is incorporated herein by reference thereto. Modifications and adjustments of the exemplary embodiments and the examples are possible within the scope of the overall disclosure (including the claims) of the present invention and based on the basic technical concept of the present invention. In addition, various combinations and selections of various disclosed elements (including the elements in each of the claims, exemplary embodiments, examples, drawings, etc.) are possible within the scope of the claims of the present invention. Namely, the present invention of course includes various variations and modifications that could be made by those skilled in the art according to the overall disclosure including the claims and the technical concept. In particular, the present description discloses numerical value ranges. However, even if the description does not particularly disclose arbitrary numerical values or small ranges included in the ranges, these values and ranges should be deemed to have been specifically disclosed.

### REFERENCE SIGNS LIST

10, 10A, 10B control apparatus

11 route information storage unit

12, 12-1 to 12-N path calculation unit

13 path information

13A path information storage unit

14-1 to 14-Ncontrol information creation unit

15 control information

15A control information storage unit

16 control information setting unit

17 interface table

18 address resolution table

19 BGP processing unit

20 topology information storage unit

What is claimed is:

1. A control apparatus, comprising:
a route information storage unit configured to store information for obtaining a neighboring router(s) set as a next hop(s) for a destination;
a path calculation unit configured to calculate a path(s) between arbitrary control target nodes on the basis of a network topology configured by a plurality of control target nodes; and
a plurality of control information creation units configured to create control information set in the plurality of control target nodes;
wherein, indivisual one of control information creation units, as for a destination allocated to itself among destinations obtained from the route information storage unit, creates control information for causing at least one control target node on a path(s) to forward packets to the neighboring router(s) by using a path(s) calculated by the path calculation unit.

2. The control apparatus according to claim 1;
wherein at least one neighboring router is allocated to each of the control information creation units; and
wherein, said each of control information creation units determines whether or not a destination obtained from the route information storage unit is a destination allocated to itself depending on or not that the obtained destination corresponds to a neighboring router allocated to the control information creation unit.

3. The control apparatus according to claim 1, further comprising:
an interface information storage unit in which information about the neighboring router(s) stored in the route information storage unit and information about the control target nodes connected to a neighboring router(s) are associated with each other;
wherein at least one control target node is allocated to each of the control information creation units; and
wherein, when said each of control information creation units obtains a destination from the route information storage unit and determines that the destination is a destination allocated to itself depending on or not that the obtained destination corresponds to a neighboring router connected to a control target node allocated to the control information creation unit itself.

4. The control apparatus according to claim 3;
wherein the path calculation unit is provided in plurality; and
wherein each of the path calculation units calculates at least one path in which a control target node allocated to itself is set as a sink and provides a control information creation unit to which the control target node is allocated with the path.

5. The control apparatus according to claim 1;
wherein the path calculation unit selects one of the plurality of control target nodes and calculates a shortest path tree in which the control target node is set as a sink.

6. The control apparatus according to claim 1;
wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

7. The control apparatus according to claim 1, further comprising a border gateway protocol processing unit configured to acquire path information from a router in a neighboring autonomous system and store the path information in the route information storage unit.

8. A communication system, comprising:
a plurality of control target nodes; and
a control apparatus;
wherein the control apparatus comprises:
a route information storage unit configured to store information for obtaining a next hop(s) each for a destination;
a path calculation unit configured to calculate a path(s) between arbitrary control target nodes on the basis of a network topology configured by the plurality of control target nodes; and
a plurality of control information creation units configured to create control information set in the plurality of control target nodes;
wherein, each of control information creation units, as for a destination allocated to itself among destinations obtained from the route information storage unit, creates control information for causing at least one control target node on a path(s) to forward packets to the neighboring router(s) by using a path(s) calculated by the path calculation unit.

9. A control information creation method, comprising:
causing a control apparatus, which comprises: a route information storage unit configured to store information for obtaining a neighboring router(s) set as a next hop(s) for a destination; a path calculation unit configured to calculate a path(s) between arbitrary control target nodes on the basis of a network topology configured by a plurality of control target nodes; and a plurality of control information creation units configured to create control information set in the plurality of control target nodes, to determine whether or not a destination obtained from the route information storage unit is a destination allocated to itself, by indivisual one of the control information creation units; and
causing the control apparatus, to create control information for causing at least one control target node on a path(s) to forward packets to a neighboring router(s) determined as allocated to itself by using a path(s) calculated by the path calculation unit.

10. A non transitory computer-readable recording medium storing thereon a program, causing a computer, which constitutes a control apparatus comprising: a route information storage unit configured to store information for obtaining a neighboring router(s) set as a next hop(s) for a destination; a path calculation unit configured to calculate a path(s) between arbitrary control target nodes on the basis of a network topology configured by a plurality of control target nodes; and a plurality of control information creation units configured to create control information set in the plurality of control target nodes, to perform processing for:
determining whether or not a destination obtained from the route information storage unit is a destination allocated to itself, by indivisual one of the control information creation units; and
creating control information, as to a destination determined as allocated to itself, for causing at least one of the control target nodes on a path(s) to forward packets to the neighboring router(s) by using a path(s) calculated by the path calculation unit.

11. The control apparatus according to claim 2,
wherein the path calculation unit selects one of the plurality of control target nodes and calculates a shortest path tree in which the control target node is set as a sink.

12. The control apparatus according to claim 3,
wherein the path calculation unit selects one of the plurality of control target nodes and calculates a shortest path tree in which the control target node is set as a sink.

13. The control apparatus according to claim 4,
wherein the path calculation unit selects one of the plurality of control target nodes and calculates a shortest path tree in which the control target node is set as a sink.

14. The control apparatus according to claim 2,
wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

15. The control apparatus according to claim 3,
wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

16. The control apparatus according to claim 4,
wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

17. The control apparatus according to claim 5,
wherein each of the control information creation units creates control information for causing a control target node connected to a neighboring router set as a next hop to rewrite a destination MAC address to a previously resolved destination MAC address, rewrite a source MAC address to a MAC address allocated to an exit port of the control target node located at the path sink.

18. The control apparatus according to claim 2, further comprising a border gateway protocol processing unit configured to acquire path information from a router in a neighboring autonomous system and store the path information in the route information storage unit.

19. The control apparatus according to claim 3, further comprising a border gateway protocol processing unit configured to acquire path information from a router in a neighboring autonomous system and store the path information in the route information storage unit.

20. The control apparatus according to claim 4, further comprising a border gateway protocol processing unit configured to acquire path information from a router in a neighboring autonomous system and store the path information in the route information storage unit.
